(19) United States
(12) Patent Application Publication
(10) Pub. No.: US 2013/0180747 A1
(43) Pub. Date: Jul. 18, 2013

(54) POWER TOOL AND OPERATION METHOD THEREOF

(71) Applicants: Warren Brown, Mount Evelyn (AU); Harry Szommer, Berwick (AU); Graham Gerhardt, Warrandyte (AU); Hua Gu, Suzhou (CN); Hui Li, Suzhou (CN); Dean Lu, Suzhou (CN)

(72) Inventors: Warren Brown, Mount Evelyn (AU); Harry Szommer, Berwick (AU); Graham Gerhardt, Warrandyte (AU); Hua Gu, Suzhou (CN); Hui Li, Suzhou (CN); Dean Lu, Suzhou (CN)

(73) Assignee: POSITEC POWER TOOLS (SUZHOU) CO., LTD, Suzhou, Jiangsu (CN)

(21) Appl. No.: 13/702,265

(22) PCT Filed: Jul. 26, 2012
(86) PCT No.: PCT/CN12/79209

§ 371 Date: Mar. 7, 2013

(30) Foreign Application Priority Data
Jul. 26, 2011 (CN) 201110210765.4

(51) Int. Cl. B25B 21/00

(52) U.S. Cl. CPC B25B 21/00
USPC 173/145

(57) ABSTRACT

The power tool includes a housing, an output shaft for fixing and driving a head to work, the output shaft being provided with a receiving portion extending out of the housing, a locking member for locking the head on the receiving portion of the output shaft, a fastener supported on the output shaft for fastening the locking member, and a driving mechanism rotatably displaced on the housing. The driving mechanism is operable to rotate along a first direction to make the fastener and the locking member screwed, and also is operable to rotate along a direction opposite to the first direction to loosen the fastener and the locking member. The power tool can assemble or disassemble the head quickly and provide a stable axial press to avoid the slippage of the head without any other auxiliary tools. Meanwhile, the operation method of the power tool is easy and reliable.

### CROSS REFERENCE TO RELATED APPLICATION

This application claims the priority of Chinese Patent Application No. 201110210765.4, filed on Jul. 26, 2011 in the SIPO (State Intellectual Property Office of the P.R.C). Further, this application is the National Phase application of International Application No. PCT/CN2012/079209 filed Jul. 26, 2012, which designates the United States.

### TECHNICAL FIELD

The present invention relates to a power tool, in particular to a hand-clamped power tool and an operation method thereof.

### BACKGROUND OF THE INVENTION

An Oscillation tool is a common hand-clamped oscillation power tool in this field. Its working principle is that the output shaft oscillates around its own axis. Therefore, many different operation functions such as sawing, cutting, grinding and scraping can be realized to meet different demands by installing different heads on the free end of the output shaft such as a straight saw blade, circular saw blade, triangular sanding plate, and shovel-shaped scraper.

Chinese patent application with a Publication No. of CN101780668A discloses an oscillation tool, which comprises a motor, wherein a motor shaft of the motor is connected with an eccentric pin, and the eccentric pin is sleeved with a bearing, thus forming an eccentric wheel structure. When the motor shaft rotates, the eccentric structure can eccentrically rotate around the axis of the motor shaft. The output shaft of the oscillation tool is vertical to the motor shaft; the output shaft is fixedly connected with a fork assembly; the fork assembly has two opposite extension arms to embrace the eccentric wheel structure; the inner sides of both extension arms have close contact with the bearing in the eccentric wheel structure such that the eccentric wheel structure drives a fork to swing horizontally when rotating eccentrically; and the fork is fixedly connected with the output shaft, so the output shaft oscillates around its axis. In cases when the free end of the output shaft is installed with different heads, the oscillation tool can realize multiple operation functions during oscillation motion at a high speed.

However, the existing oscillation tool still adopts a relatively out-date head installation means, which means that the locking member is installed on or taken down from the output after the fastening bolts are loosened with a wrench; likewise, the same way is adopted for installation and replacement of attachments, and the head is replaced, screwed, and installed by loosening the fastening bolts with the wrench. The operation is very complicated and wastes time and energy.

Thus, it is necessary to provide an improved power tool to solve the above problems.

### SUMMARY OF THE INVENTION

The object of the invention is providing a power tool which can install a head to an output shaft in a reliable way to avoid the slippage of the head without any auxiliary tools like wrenches.

To achieve the object, the solution of the invention is as below: A power tool comprises: a housing, an output shaft for fixing and driving a head to work, the output shaft being provided with a receiving portion extending out of the housing, a locking member for locking the head on the receiving portion of the output shaft, a fastener supported on the output shaft for fastening the locking member, and a driving mechanism rotatably displaced on the housing. The driving mechanism is operable to rotate along a first direction to make the fastener and the locking member screwed, and also is operable to rotate along a direction opposite to the first direction to loosen the fastener and the locking member.

In a preferred embodiment, said driving mechanism comprises an operating assembly and a driving assembly connected with the operating assembly; said operating assembly is operable to move said driving assembly to be engaged or disengaged with said fastener.

In a preferred embodiment, a biasing member is axially arranged between said driving assembly and said housing, which provides a spring force such that said driving assembly can axially move in a reciprocating way.

In a preferred embodiment, said operating assembly is a handle pivoted on said driving assembly; said handle is provided with a cam portion; said cam portion is matched with said housing to axially move said driving assembly.

In a preferred embodiment, said operating assembly comprises a sleeve installed on said housing and the handle pivoted on said sleeve; and a first biasing member is arranged between said driving assembly and said sleeve.

In a preferred embodiment, said driving assembly comprises a supporting member axially supported on said sleeve and a driving member axially supported on said supporting member; and a second biasing member is axially arranged between said supporting member and said driving member.

In a preferred embodiment, said driving member comprises a first driving member and a second driving member; said second driving member is always engaged with said fastener and can move axially relatively; and said operating member drives said second biasing member to be engaged with the first driving member so as to drive said fastener to rotate.

In a preferred embodiment, said locking member comprises a pole portion capable of being inserted into said output shaft; the free end of said pole portion is provided with external screw threads; said fastener is provided with a threaded bore; and said threaded bore is provided with internal screw threads capable of being engaged with said external screw threads of said pole portion.

In a preferred embodiment, said fastener can move axially.

In a preferred embodiment, said driving mechanism is located at an end away from said receiving portion of said output shaft.

In a preferred embodiment, the rotation angle of said driving mechanism is more than 90 degrees.

In a preferred embodiment, the rotation angle of said driving mechanism is more than 360 degrees and less than 1,080 degrees.

In a preferred embodiment, said operation assembly comprises a handle rotatable relative to said housing, said handle comprises a block which can fix said handle and said housing.

Another object of the invention is providing a operation method for installing a head into a power tool which can avoid the slippage of the head while working without any auxiliary tools like wrenches.

To achieve the object, the solution of the invention is as below: An operation method for installing a head into a power tool, wherein said power tool comprises: a housing; an output shaft for installing and driving the head to work, said output shaft being provided with a receiving portion that extends out of said housing; a locking member for fixing said head on said receiving portion of said output shaft; a fastener supported on said output shaft for locking said locking member; and a driving mechanism, rotationally installed on said housing; the operation method comprising the following steps: first, installing said head between said receiving portion of said output shaft and said locking member; and second, rotating said driving mechanism around the axis of said output shaft along one direction to drive said fastener and said locking member to be locked by screw threads.

In a preferred embodiment, said driving mechanism comprises an operating assembly and a driving assembly connected with the said operating assembly; the operation method also comprises the following step: said operating assembly axially drives said driving assembly to be engaged or disengaged with said fastener before the driving mechanism is rotated.

In a preferred embodiment, the rotation angle of said driving mechanism is more than 90 degrees.

In a preferred embodiment, the rotation angle of said driving mechanism is more than 360 degrees and less than 1,080 degrees to fix the fastener and the locking member screwed.

In a preferred embodiment, rotate along a direction opposite to the first direction to loosen the fastener and the locking member.

In a preferred embodiment, when said locking member inserted into said output shaft, it brings said fastener move axially.

The advantage of the invention is: quickly drive the fastener and the locking member screwed or loosened to fast assemble or disassemble the head without any other auxiliary tools by the drive mechanism installed on the housing. Because of driving the fastener and the locking member screwed through rotating the driving mechanism several circles, it assure the axial press force on the head is high enough to reliably installing the head on the output shaft and avoid slippage of the head in any environments to improve the working efficiency.

### BRIEF DESCRIPTION OF THE DRAWINGS

FIG. 1 is a sectional view of part of a power tool at a first position in the first embodiment of the present invention, wherein the handle is located at the initial position and the locking member is not inserted into said output shaft.

FIG. 2 is a three-dimensional exploded view of some components in the power tool shown in FIG. 1.

FIG. 3 is a sectional view of part of the power tool at a second position in FIG. 1, wherein the locking member is inserted into the output shaft and the fastener is not screwed.

FIG. 4 is a sectional view of part of the power tool at a third position in FIG. 1, wherein the handle is pivoted to the open position, and the driving mechanism is engaged with the fastener.

FIG. 5 is a sectional view of part of the power tool at a fourth position in FIG. 1, wherein the fastener and the locking member are axially locked after the handle is rotated for several circles.

FIG. 6 is a sectional view of part of the power tool at a fourth position in FIG. 1, wherein the handle is pivoted to the initial position, and the driving mechanism is disengaged with the fastener.

FIG. 7 is a sectional view of part of a power tool at a first position in the second embodiment of the present invention, wherein the handle is located at the initial position; the locking member is inserted into said output shaft, and the fastener is not screwed.

FIG. 8 is a three-dimensional exploded view of some components in the power tool shown in FIG. 7.

FIG. 9 is a sectional view of part of the power tool at a second position in FIG. 7, wherein the handle is pivoted to the open position, and the driving mechanism is engaged with the fastener.

FIG. 10 is a sectional view of part of the power tool at a third position in FIG. 7, wherein the handle is pivoted to the open position, and the driving mechanism is engaged with the fastener.

FIG. 11 is a partial sectional view of a power tool in the third embodiment of the present invention, wherein the handle is pivoted to the open position, and the driving mechanism is engaged with the fastener.

FIG. 12 is a sectional view of part of a power tool at a first position in the fourth embodiment of the present invention, wherein the locking member is inserted into the output shaft, and the supporting member is not engaged with the driving member.

FIG. 13 is a sectional view of part of the power tool at a second position in FIG. 11, wherein the handle is pivoted to the open position, and the supporting member is engaged with the driving member.

FIG. 14 is a sectional view of part of the power tool at a third position in FIG. 11, wherein the handle is pivoted to the initial position, and the driving mechanism is disengaged with the fastener.

### DETAILED DESCRIPTION OF THE INVENTION

The present invention is further described in detail with reference to the attached drawings and the specific embodiments.

### Embodiment 1

The power tool described in this embodiment is an oscillating type power tool, also called an oscillation tool. However, the present invention is not limited to oscillating-type power tools, and also may be a rotary type grinding power tool, such as a sander or an angle grinder.

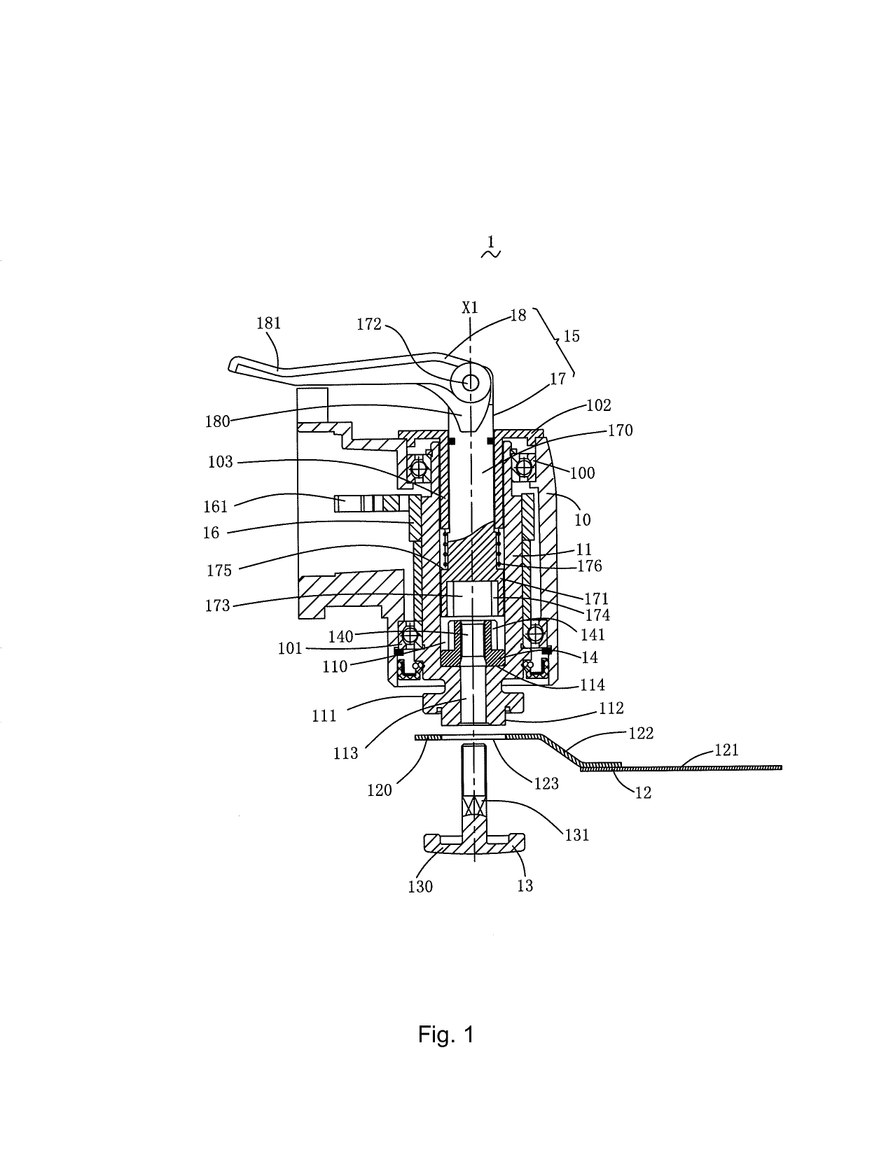

FIG. 1 illustrates the head area of the oscillation tool 1 in this embodiment. The oscillation tool 1 has a housing 10, an output shaft 11 extending out from the housing 10, a head 12 installed at the end of the output shaft 11, a locking member 13 for fixing the head 12 at the end of the output shaft 11, a fastener 14 supported in the output shaft 11, and a driving mechanism 15 capable of rotating around the axis X1 of the output shaft 11. When rotated along one direction, the driving mechanism 15 can drive the fastener 14 and the fastener 13 to be screwed; and when rotated along the opposite direction, the driving mechanism 15 can drive the fastener 14 and the locking member 13 to be loosened.

In comparison with the rotary type power tool, when the oscillation tool 1 is working, the output shaft 11 rotates around its own axis X1 to oscillate in a reciprocated way such that large breaking torques are generated along the two oscillation directions. Therefore, a huge axial holding force is needed to ensure that the head 12 is fixed on the output shaft 11 under all working conditions, and to avoid slippage so as to guarantee the working efficiency or normal regular work. The oscillation tool 1 provided in this embodiment can meet the above demands and can quickly clamp and release the head 12 without auxiliary tools.

The housing 10 of the oscillation tool 1 is also provided with a motor (not shown in the figure) and an eccentric transmission mechanism which converts the rotation output from the motor shaft into oscillation motion of the output shaft 11 inside. The eccentric transmission mechanism comprises an eccentric member (not shown in the figure) installed on the motor shaft and a fork 16 sleeved on the output shaft 11; and the eccentric member is surrounded by two sliding surfaces 161 of the fork. When rotating, the eccentric member converts its rotation by fitting the fork 16 into the oscillation of the output shaft 11 around its own axis X1, wherein the oscillation angle is about 0.5-7 degrees, and the oscillation frequency can be set to be 5,000-30,000 turns/min.

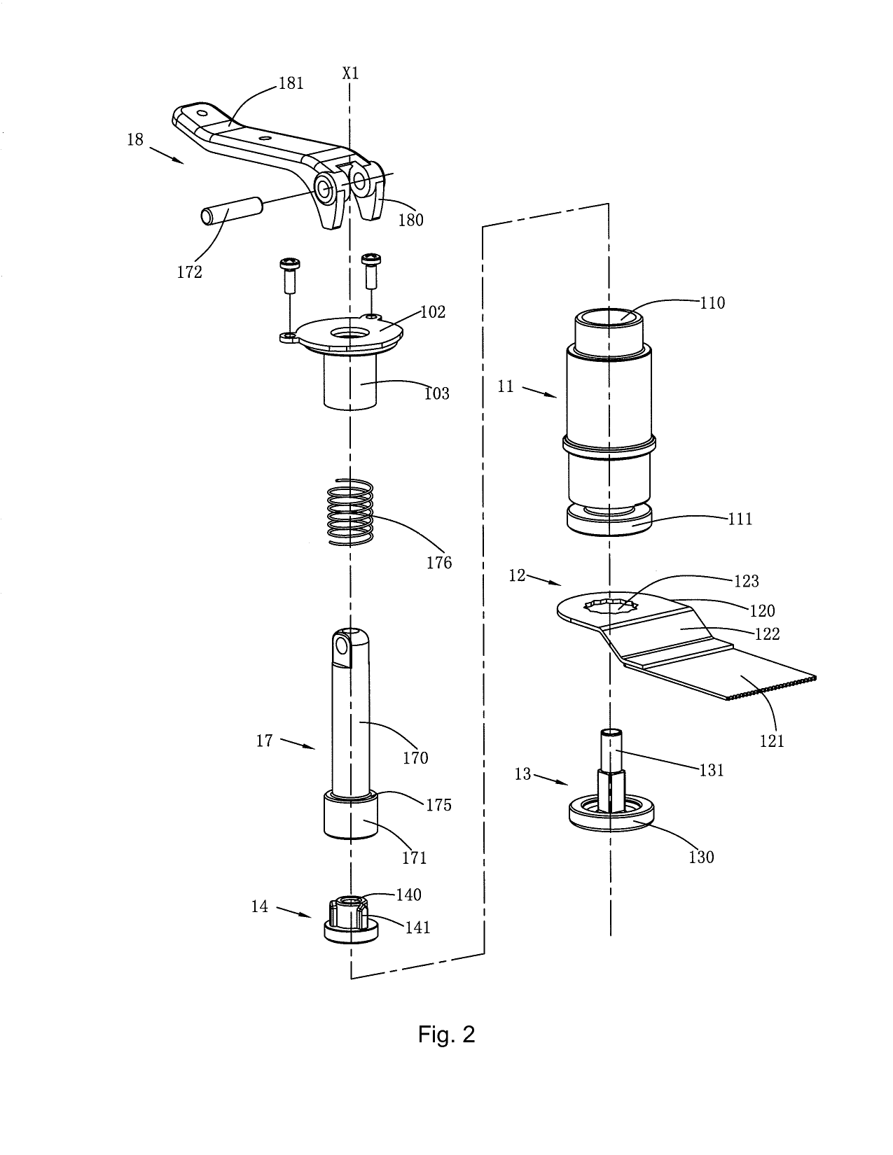

As shown in FIG. 1 and FIG. 2, the direction of the straight line where the axis X1 of the output shaft 11 exists is defined as the lengthwise direction, while the direction vertical to the axis X1 is defined as the crosswise direction; the bottom of the paper is downward, and the top of the paper is upward. The following descriptions all adopt such definition. The output shaft 11 is hollow, longitudinally supported between two rolling bearings 100 and 101 of the housing 10. The upper part of the output shaft 11 is received in the housing 10 and is provided with a cavity 110; the lower end is provided with a flange plate 111 that extends out of the housing 10; the middle part of the flange plate 111 extends downward and out of the receiving portion 112 for installing the head 12; and the middle part of the lower end is also formed with an axial bore 113 which is connected with the cavity 110.

The head 12 is a straight saw blade. Those skilled in this field can easily figure out that head 12 may be other attachments such as a circular saw blade, sanding plate, or scrapper. The head 12 may be transversely arranged and has a plate-like fixing part 120 installed on the output shaft 11, a cutting part 121 for cutting and a connecting part 122 located between the fixing part 120 and the cutting part 121.

The locking member 13 is used for fixing the head 12 on the receiving portion 112 of the output shaft 11. The locking member 13 passes through the fixing part 120 of the head 12 and then is connected into the output shaft 11. The locking member 13 comprises a ring-shaped flange portion 130 located at the bottom and a pole portion 131 axially extending upward from the middle part of the flange portion 130; the tail end of the pole portion 131 is provided with external screw threads; and after being received in the bore 113, the pole portion 131 cannot rotate with respect to the output shaft 11. During installation, the pole portion 131 of the locking member 13 passes through the bore 113 of the output shaft 11 and is treaded with the fastener 14 such that the head 12 is fixed on the receiving portion 112 of the output shaft 11 and clamped between the bottom face of the flange plate 111 and the top face of the flange portion 130.

The fastener 14 is received in the cavity 110 of the output shaft 11 and can be axially moveably supported on the bottom 114 of the cavity 110. The fastener 14 is approximately shaped like a circular ring and can freely rotate in the cavity 110; the middle part thereof is axially formed with a threaded bore 140; and the periphery is circumferentially provided with a first gear portion 141 which is connected with the driving mechanism 15 in a non-rotary way with respect to the axis X1. When rotated along one direction, the driving mechanism 15 drives the fastener 14 to rotate with respect to the axis X1 such that the threaded bore 140 of the fastener 14 is treaded with the pole portion 131 of the locking member 13. In the locked state, when rotated toward the opposite direction, the driving mechanism 15 drives the fastener 14 to reversely rotate with respect to the axis X1 such that the threaded bore 140 of the fastener 14 is divorced from the pole portion 131 of the locking member 13.

It should be noted that, in this embodiment, the locking member 13 has the pole portion, but the fastener 14 has the threaded bore. The present invention is not limited to such structure. Those skilled in this field can easily figure out that the pole portion may also arranged on the fastener while the threaded bore is formed on the locking member, wherein the locking member shall also be set to not rotate with respect to the output shaft. Besides, the screw thread fit described in the present invention may be single-thread fit or dual-thread or multithread fit; the threads are not limited in size and may be coarse threads or fine thread; the screw threads may be triangular, rectangular, trapezoidal, or saw-tooth-shaped.

When oscillating, the output shaft 11 can drive the head 12, the locking member 13, and the fastener 14 to oscillate together. Some components of the driving mechanism in this embodiment shall be installed on the exterior of the housing such that the operator can directly manually operate the driving mechanism without other auxiliary tools. If the fastener in oscillation drives the driving mechanism to oscillate synchronously, the operation feel of the operator will be influenced, and even problems regarding safety may occur in some cases, so after being locked, the fastener shall be prevented from driving the driving mechanism to oscillate synchronously.

The driving mechanism 15 adopted in this embodiment may be selectively engaged with the fastener 14. When the fastener 14 and the locking member 13 are required to be relatively locked or loosened, the driving mechanism 15 can be selected to be engaged with the fastener 14 and then drive the fastener 14; when the fastener 14 works after being locked, the driving mechanism 15 is disengaged with the fastener 14 and therefore is not influenced by the oscillation of the fastener 14.

The driving mechanism 15 comprises a driving assembly 17 and an operating assembly 18, wherein the driving assembly is used for engaging the fastener 14 and driving the fastener 14 to rotate; while the operating assembly 18 is used for manual operation to drive the driving assembly 17 to rotate.

The driving assembly 17 is received in the cavity 110 of the output shaft 11 and located above the fastener 14. The driving assembly 17 comprises a vertical cylindrical lever portion 170 and a driving portion 171 located at the lower part; one end, extending out from the top of the housing 10, of the lever portion 170, is installed with a shaft 172; and the driving portion 171 is axially formed with a groove 173 from the bottom, wherein, the axis of the shaft 172 is vertical to the axis X1 of the output shaft 11. The shape of the groove 173 is matched with that of the fastener 14; the groove 173 is provided with a second gear portion 174 inside capable of being engaged with the first gear portion 141 of the fastener 14. When the driving assembly 17 is engaged with the fastener 14, the groove 173 is sleeved on the periphery of the fastener 14 and drives the fastener 14 to rotate through the fit between the first gear portion 141 and the second gear portion 174. Besides, the radial size of the driving portion 171 is bigger than that of the pole portion 170 such that the top of the driving portion 171 forms an annular step portion 175.

The operating assembly 18 is an operating handle pivoted on the lever portion 170 of the driving assembly 17 by the shaft 172. One side of the operating assembly 18, with respect to the shaft 172, is provided with a cam portion 180, while the other side extends to form a handle 181 approximately vertical to the cam portion 180; the tail end of the handle 181 has a certain distance away from the axis X1 such that the driving assembly 17 can be easily driven to rotate around the axis X1 by the operating handle 181.

The top of the housing 10 is installed with a plate-like casing 102 sleeved on the driving assembly 17, and the casing 102 can seal the housing 10 to prevent the bearing 100 from pollution by dust. An annular shaft sleeve 103 is axially arranged between the pole portion 170 of the driving assembly 17 and the inner wall of the cavity 110 of the output shaft 11. The shaft sleeve 103 is integrally molded with the casing 102, and its bottom faces the step portion 175 of the driving assembly 17. Furthermore, a spring 176 is arranged between the bottom end of the shaft sleeve 103 and the step portion 175 of the driving assembly 17 to provide a spring force by which the driving assembly 17 can move in a reciprocating way.

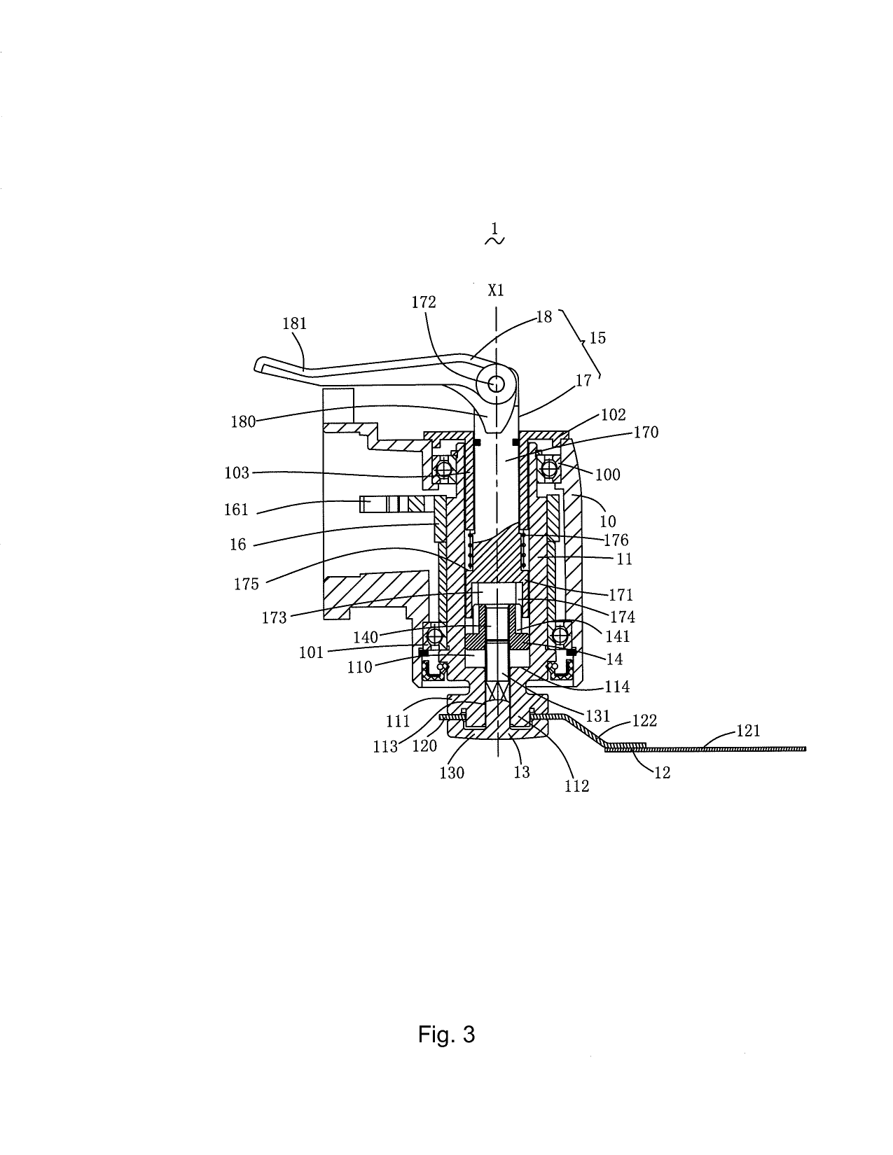

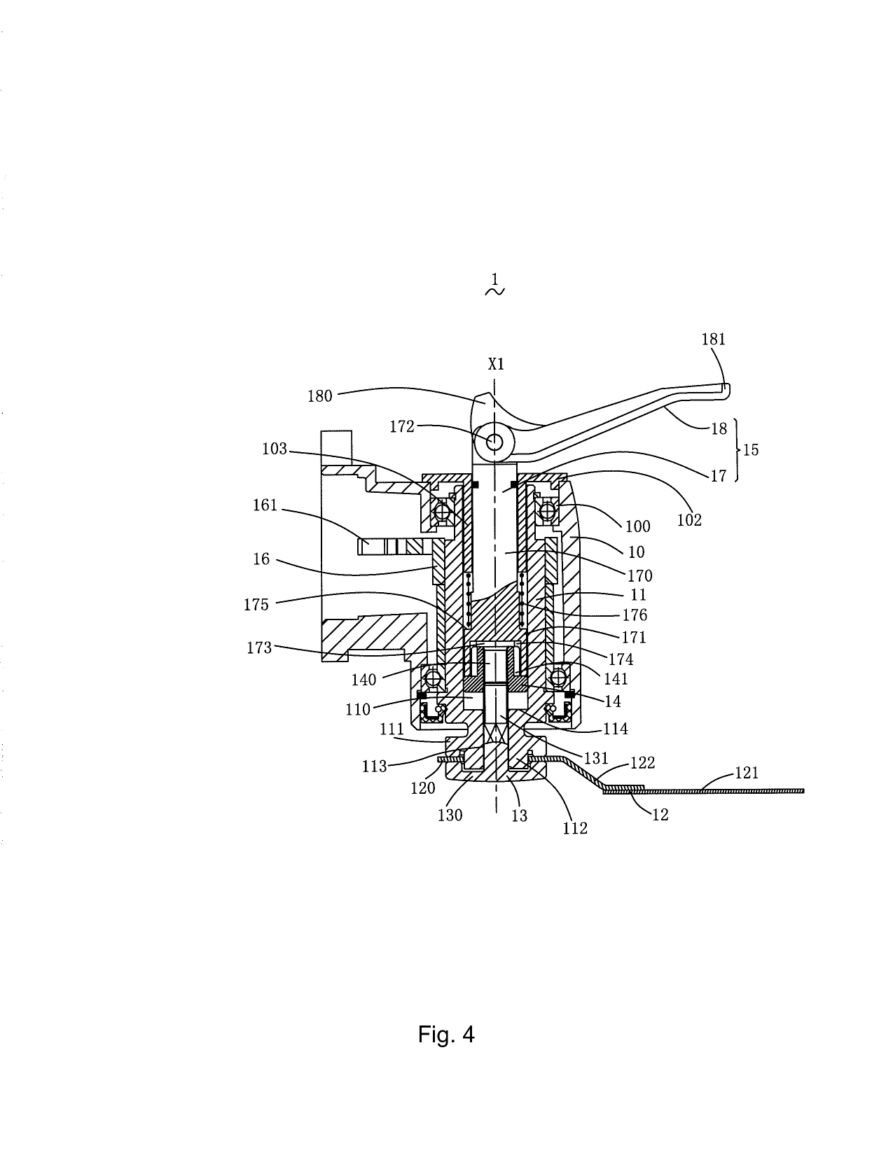

As shown in FIGS. 1 and 4, the operating assembly 18 moves from the initial position to the open position. As shown in FIG. 3, at the initial position, the handle 181 is adhered to the top of the housing 10, and the cam portion 180 extends towards the head 12 and is pressed above the casing 102. At this moment, the spring 176 is axially compressed at a certain distance, and the driving portion 171 of the driving assembly 17 is axially kept at a certain distance away from the fastener 14, namely in the non-engaged state. As shown in FIG. 4, when the operating assembly 18 rotates 180 degrees around the shaft 172 to the open position, the cam portion 180 rotates to one side back to the casing 102 to be not matched with the casing 102. Driven by the spring 176, the driving assembly 17 axially moves downward at a certain distance, and the driving portion 171 is engaged with the fastener 14 to drive the fastener 14 to rotate together such that the fastener 14 and the locking member 13 lock through the screw threads. Obviously, after the fastener 14 and the locking member 13 lock through the screw threads, the operating assembly 18 is shifted from the open position to the initial position, and then the cam portion 180 is matched with the casing 102 again such that the driving assembly 17 moves upward at a certain distance to be disengaged with the fastener 14, meanwhile the driving assembly 17 compresses the spring 176.

It should be noted that, in this embodiment, being engaged or disengaged with the fastener is realized by axial movement of the driving assembly, but the present invention is not limited to such means. Those skilled in this field can easily figure out other realization means which are feasible as long as the fastener is prevented from driving the driving assembly to oscillate together during oscillation. For example, the bottom of the driving assembly can be provided with a flat square groove, while the top of the fastener is provided with a flat square portion matched with the flat square groove, and the flat square groove and the flat square portion are matched and form a certain gap in the radial area; the gap can ensure that the fastener oscillates in a scope of 0.5-5 degrees and does not interfere with the driving assembly; however, the driving assembly can drive the fastener to rotate together when rotating. Besides, the driving assembly and the fastener also can transmit the rotary motion by a flat square end-tooth fit or transmit torque by a non-round fit section.

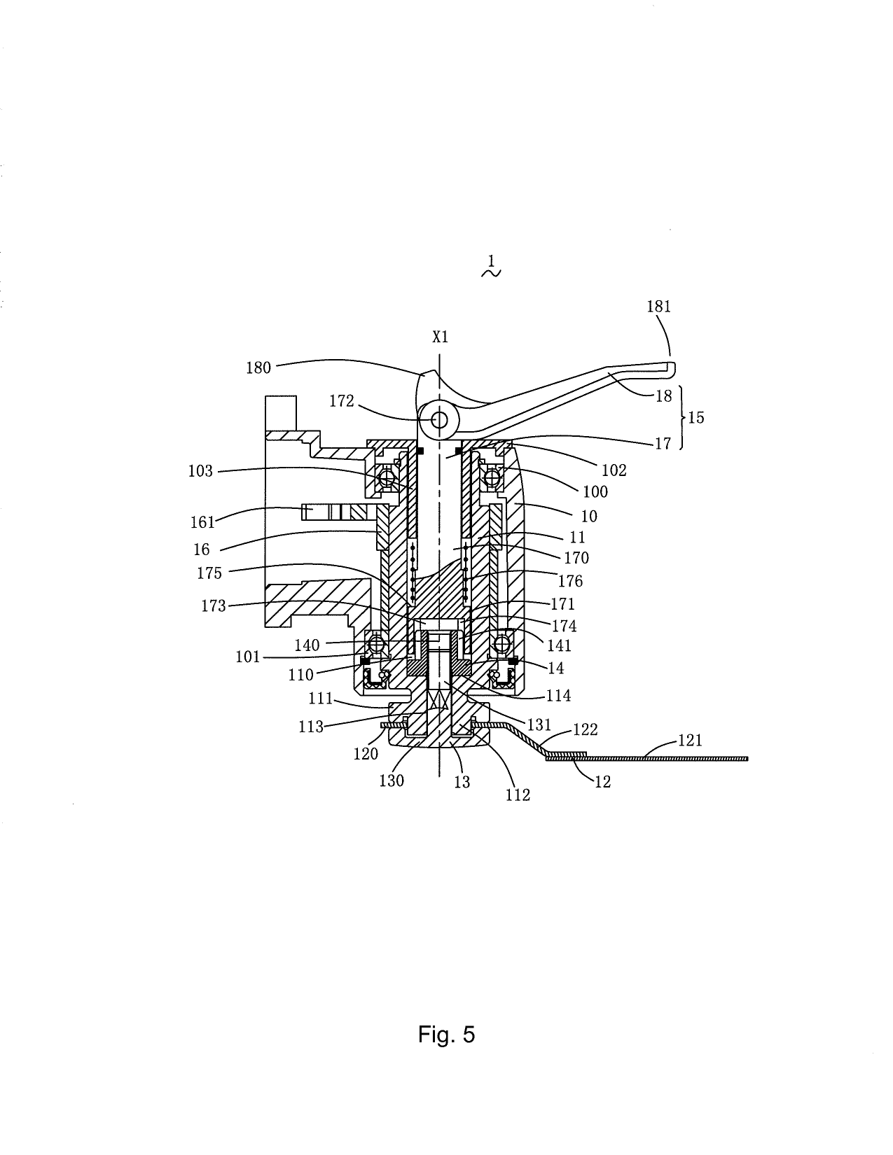

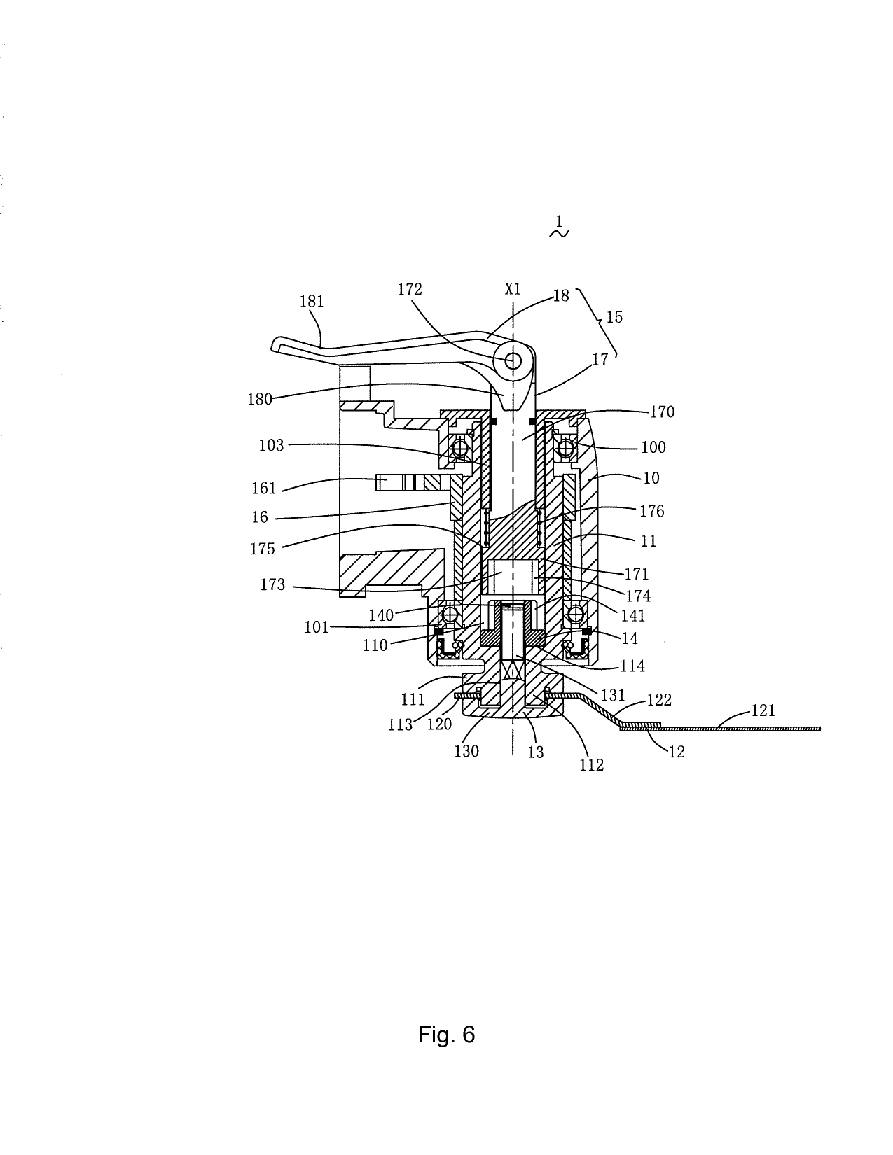

As shown in FIGS. 1 and 3-6, the operation method for installing the head 12 on the oscillation tool 1 is described in detail with reference to five location views of the oscillation tool 1. In FIG. 1, the oscillation tool 1 is located at the first position; the handle 181 is located at the initial position; and the locking member 13 is not inserted into the output shaft 11. As shown in FIG. 3, the oscillation tool 1 is located at the second position while the locking member 13 is inserted into the output shaft 11, but the fastener 14 is not screwed. As shown in FIG. 4, the oscillation tool 1 is located at the third position; the handle 181 is pivoted to the open position; and the driving mechanism 15 is engaged with the fastener 14. As shown in FIG. 5, the oscillation tool 1 is located at the fourth position; and the fastener 14 and the locking member 13 are axially locked after the handle 181 rotates for several circles. As shown in FIG. 6, the oscillation tool 1 is at the fourth position; the handle 181 is pivoted to the initial position; and the driving mechanism 15 is disengaged with the fastener 14. The following is the description of the detailed operation process:

As shown in FIG. 1, the head 12 is first installed between the receiving portion 112 of the output shaft 11 and the locking member 13; the opening 123 on the fixing part 120 of the head 12 is closed, so the fastener 14 and the locking member 13 shall be completely disengaged to be take down the locking member 13 from the output shaft 11, and then locking member 13 passes through the opening 123 of the head 12 to be installed in the output shaft 11. It should be noted that the power tool of the present invention may also process the opening of the head to be non-closed and reserve a gap for penetration of the pole portion of the locking member. In such cases, it is not required to completely take down the locking member from the fastener, and it only requires loosening the fastener such that the receiving portion between the locking member and the output shaft reserves a gap through which the fixing part of the head can pass.

As shown in FIG. 3, after the locking member 13 is inserted into the bore 113 of the output shaft 11, the external screw threads of the top of the pole portion 131 thereof contact with the threaded bore 140 of the fastener 14 and push the fastener 14 to axially move at a certain distance until the flange portion 130 of the locking member 13 is pressed against the lower surface of the fixing part 120 of the head 12 and the upper surface of the fixing part 120 of the head 12 is pressed against the lower surface of the flange plate 111 of the output shaft 11. At this moment, if the first gear portion 141 of the fastener 14 is just axially aligned with the second gear portion 174 of the driving assembly 17 and starts to be partly engaged, the two gear portions 141 and 174 collide to “click”, which was a prompt meaning that the two have been smoothly engaged; if the two gear portions 141 and 174 are not aligned, the “click” sound will not be heard, and in such cases the fastener 14 will push the driving assembly 17 to axially move at a certain distance. The present invention is not limited to this structure, which means that when the fastener is completely inserted into the output shaft, the locking member is axially moved upward at a certain distance, but is stilled not engaged with the driving assembly.

As shown in FIG. 4, when the operating assembly 18 is pivoted from the initial position to the open position, the cam portion 180 of the operating assembly 18 is disengaged with the casing 102; if the first gear portion 141 of the fastener 14 has been already engaged with the second gear portion 174 of the driving assembly 17 in the last step, the driving assembly 17 will continuously move downward at a certain distance by the action of the spring 176 such that the second gear portion 174 of the driving portion 171 is completely engaged with the first gear portion 141 of the fastener 14 on the axial; if the first gear portion 141 of the fastener 14 is not aligned and engaged with the second gear portion 174 of the driving assembly 17 in the last step, the operating handle 181 can be operated to drive the driving assembly 17 clockwise to rotate a certain angle around the axis X1, and then the two gear portions 141 and 174 will be aligned and smoothly and completely engaged together and click to give a prompt. The driving assembly 17 then is matched with the first gear 141 of the fastener 14 via the second gear portion 174 to drive the fastener 14 to rotate with respect to the locking member 13. The threaded bore 140 of the fastener 14 and the pole portion of the locking member 13 are in threaded fit, so the fastener 14 axially moves downward when rotating by the action of the rotary force of the screw threads until it is pressed against the bottom 114 of the output shaft 11.

As shown in FIG. 5, if the operating assembly 18 is continuously rotated, the driving assembly 17 can drive the fastener 14 to further move downward and remove the axial gaps between the head 12 and the locking member 13 and the flange plate 111 of the output shaft 11 until it is felt that the handle 181 is difficult to rotate; meanwhile, the head 12, the locking member 13 and the flange plate 111 of the output shaft 11 respectively have a very large axial positive pressure mutually and correspondingly have a very large friction force, so enough torque can be transmitted to prevent slippage of the head with respect to the locking member 13 and the flange plate 111 of the output shaft 11 so as to guarantee the working efficiency.

As shown in FIG. 6, after the fastener 14 and the locking member 13 are completely locked, the operating assembly 18 is pivoted back to the initial position. Then, the cam portion 180 of the operating assembly 18 axially enhances the driving assembly 17 by matching with the casing 102 such that the driving portion 171 of the driving assembly 17 is disengaged with the fastener 14 to prevent the fastener 14 from driving the driving assembly 17 to oscillate together.

According to the introduction to the operation process of installing the head 12, it can be easily understood that dismantling of the head 12 shall execute the operation in an inverted sequence. To dismantle the head 12, firstly, it needs to rotate the operating assembly 18 around the shaft 172 to the open position and make the driving assembly 17 and the fastener 14 engaged; then, the operating assembly 18 is rotated anticlockwise, and then the driving assembly 17 drives the fastener 14 to rotate with respect to the locking member 13 to loosen the treaded connection such that the locking member 13 axially moves downward at a certain distance; finally the operating assembly 18 continuous rotates until the fastener 14 and the locking member 13 are completely not threaded, then the fastener 14 can be dismantled from the output shaft 11, and the head 12 can be taken out.

According to the above description, by adopting the driving mechanism 15 installed on the housing 10, the oscillation tool 1 in the present invention can quickly drive the fastener 14 and the locking member 13 to be locked or unlocked to realize quick installation and dismantling of the head 12 without other auxiliary tools. The fastener 14 and the locking member 13 are driven to be locked through screw threads by rotating the driving mechanism 15 for several circles, so it can be ensured that the head 12 is stressed by the axial positive pressure which is big enough and therefore stably and reliably installed on the output shaft 11, thus preventing the head 12 from slippage in any working environment and improving the working efficiency of the head 12.

Besides, by further equipping the operating assembly 18 and the driving assembly 17, the driving mechanism 15 enables the driving assembly 17 to be selectively engaged with the fastener 14; when the head 12 is locked, the driving assembly 17 is disengaged with the fastener 14 through the operating assembly 18 such that the fastener 14 is prevented from driving the driving assembly 17 to move, thus reducing the friction and vibration between the driving mechanism 15 and the fastener 14 and endowing the whole tool with better operation feel. Moreover, the driving mechanism 15 is arranged on one end, away from the receiving portion 112, of the output shaft 11 and is away from the head 12, and the head 12 is not contacted when the driving mechanism 15 is operated, so the operator can be protected against injury by mistake.

In the above embodiment, the rotation angle of the driving mechanism 15 of the oscillation tool 1 is more than 90 degrees, preferably more than 360 degrees and less than 1,080 degrees. It should be noted that the power tool of the present invention drives the fastener to rotate with respect to the locking member and be finally locked through screw threads by the driving mechanism. Those skilled in this field can easily understand that the driving mechanism can rotate several circles until the fastener and the locking member are locked.

The driving mechanism of the power tool of the present invention is mainly operable to drive the fastener and the locking member to rotate with respect to each other and be locked through screw threads, but the detailed realization means of the driving mechanism is not limited to the above description in the first embodiment. The following three embodiments describe other realization means of the driving mechanism. The driving mechanism in the following embodiments may also be selectively engaged with the corresponding fastener.

### Embodiment 2

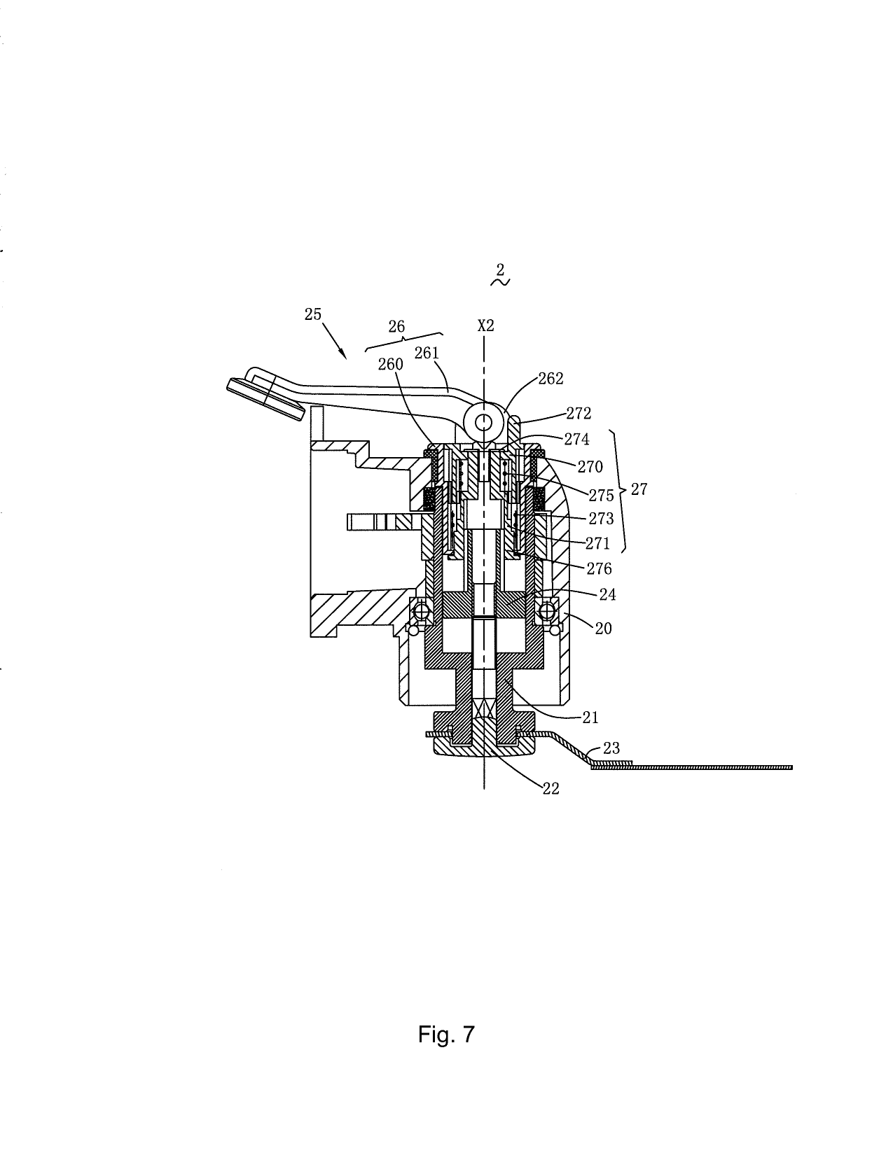

As shown in FIGS. 7-10, the second embodiment of the present invention discloses an oscillating type power tool, namely an oscillation tool 2. The oscillation tool 2 comprises a housing 20, an output shaft 21 installed in the housing 20, a locking member 22 inserted into the output shaft 21, a head 23 clamped between the locking member 22 and the output shaft 21, a fastener 24 received in the output shaft 21 and used for locking the locking member 22, and a driving mechanism 25 for driving the fastener 24 to rotate around the axis X2 of the output shaft 21.

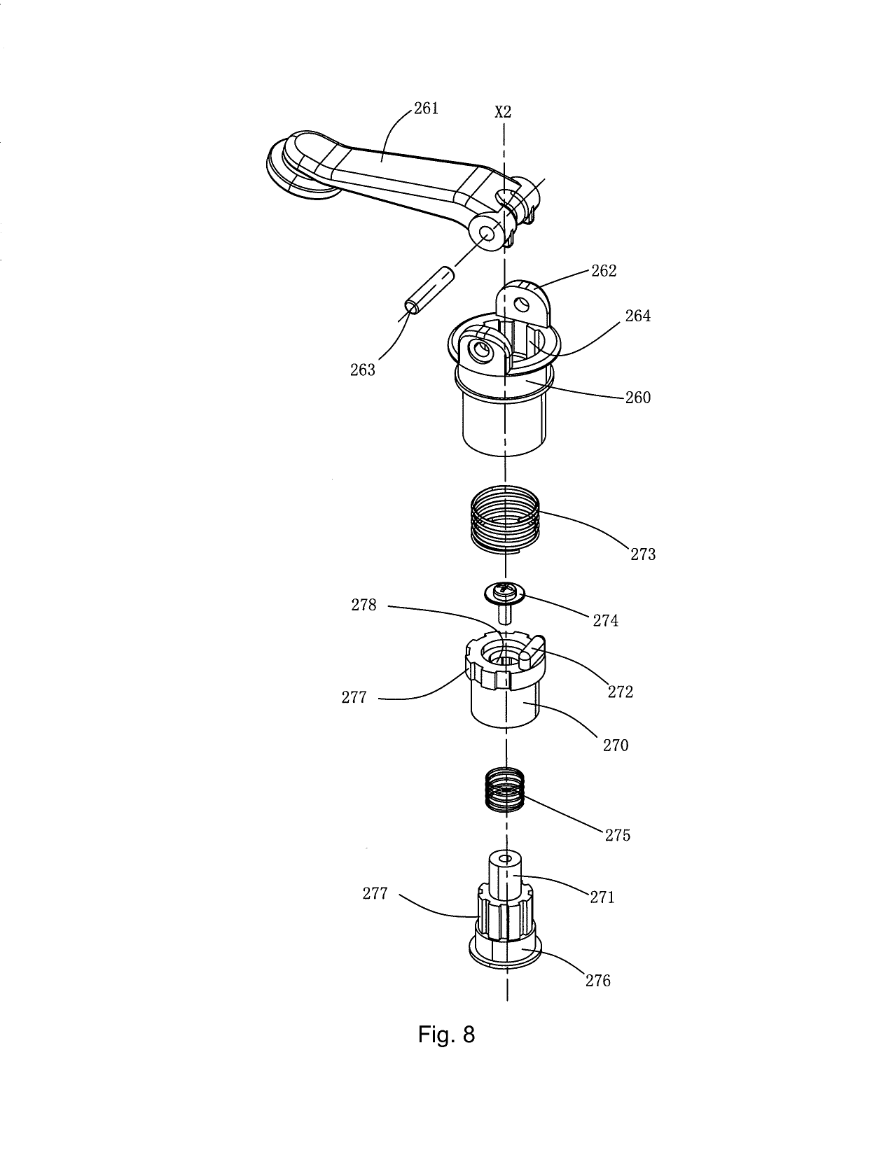

As shown in FIGS. 7 and 8, in comparison with the oscillation tool 1 in the first embodiment, the driving mechanism 25 has a different structure. The driving mechanism 25 specially comprises an operating assembly 26 and a driving assembly 27. The operating assembly 26 is operable to drive the driving assembly 27 to rotate. The operating assembly 26 comprises a cylindrical sleeve 260 installed on the top of the housing 20 and a handle 261. The sleeve 260 is axially arranged and can rotate with respect to the housing 20, the two opposite sides thereof axially extend upward to form two ear portions 262, while the bottom extends into the output shaft 21. The distal end of the handle 261 is pivoted between the two ear portions 262 by a shaft 263, and can pivot around the shaft 263 with respect to the sleeve 260 in a scope of 180 degrees.

The driving assembly 27 comprises a supporting member 270 arranged in the sleeve 260 and a driving member 271 arranged in the supporting member 270; the supporting member 270 and the driving member 271 both are approximately barrel-shaped; and the axial length of the supporting member 270 is smaller than that of the driving member 271. One side of the supporting member 270 axially extends upward to form a projecting member 272 vertical to the ear portion 262 of the sleeve 260, and the bottom thereof and the bottom of the sleeve 260 have a certain axial space there-between; a first spring 273 is arranged in this space; the supporting member 270 is axially supported on the sleeve 260 by the first spring 273 such that the supporting member 270 can axially move up and down with respect to the sleeve 260. The top of the driving member 271 is supported on the supporting member 270 by a spacer 274, and a second spring 275 is axially arranged between the driving member 271 and the supporting member 270 such that the two can relative move in the axial.

Besides, the sleeve 260 and the supporting member 270, the supporting member 270 and the driving member 271 all are matched in a way of failing to rotate relatively, which means that when rotating the sleeve 260 drives the supporting member 270 to rotate and the supporting member 270 further drives the driving member 271 to rotate. The specific structure is that: the inner wall of the sleeve 260 is provided with a plurality of first gear portions 264 at intervals, correspondingly the outer wall of the supporting member 272 is provided with a plurality of second gear portions 277 matched with the first gear portions 264; the inner wall of the supporting member 272 is also provided with a plurality of third gear portions 278 at intervals, and correspondingly the outer wall of the driving member 271 is provided with a plurality of fourth gear portions 279 matched with the third gear portions 278. The bottom of the driving member 271 is provided with a driving portion 276 capable of being sleeved on the fastener 24; the driving portion 276 and the fastener 24 are also matched in a way of failing to rotate relatively; when rotating, the driving member 271 can drive the fastener 24 to rotate by the driving portion 276.

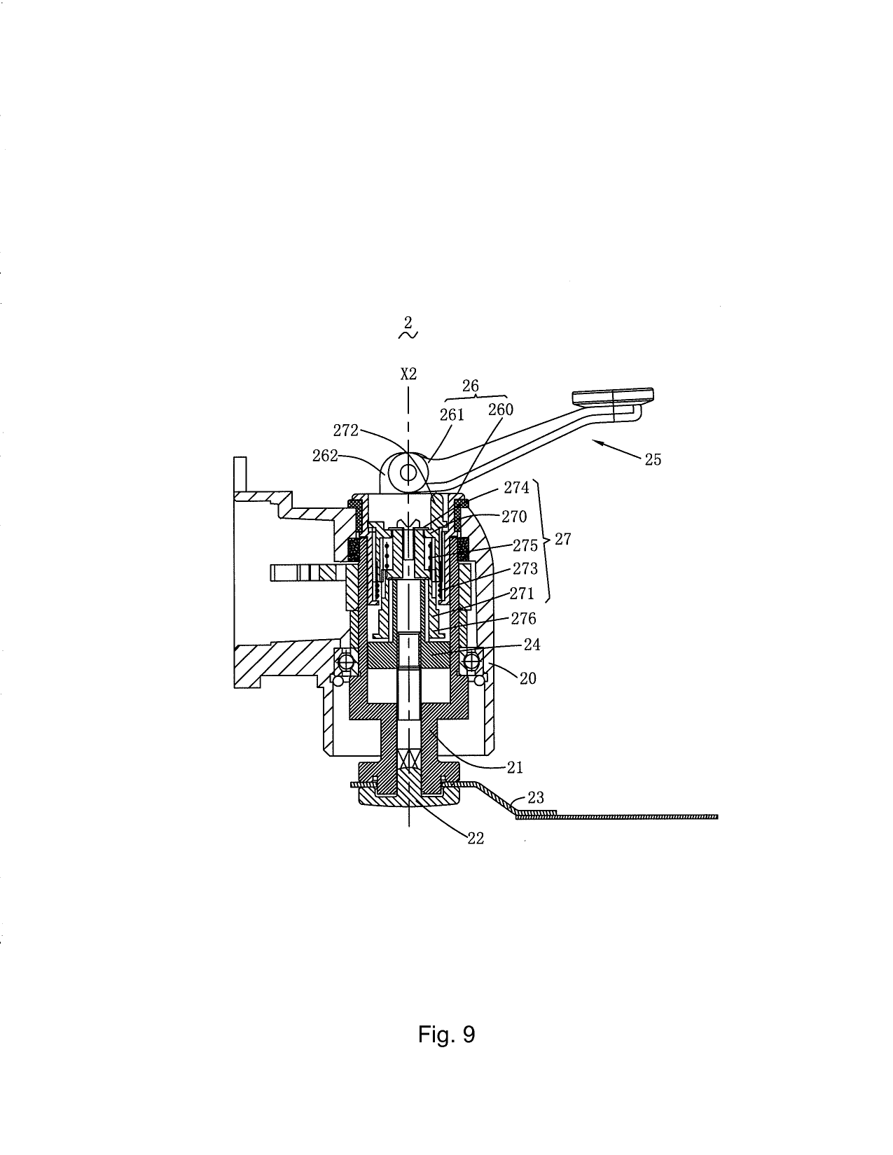

As shown in FIG. 9, in actual operation, the handle 261 can be operable to pivot from the initial position to the 180-degree open position and meanwhile extrude the projecting member 272 of the supporting member 270 to force the supporting member 270 to axially move downward. By the action of the second spring 275, the supporting member 270 drives the driving member 271 to axially move downward and be engaged with the fastener 24. The driving member 271 and the fastener 24 cannot be regularly engaged if not aligned. When the supporting member 270 moves downward, the second spring 275 is compressed to prevent the driving 271 and the fastener 24 from being clamped. Then, the handle 261 is rotated with respect to the axis X2 to start to drive the sleeve 260 to rotate by the ear portion 262 and further drive the supporting member 270 and the driving member 271 to rotate in turn. If not regularly engaged, the driving member 271 and the fastener 24 can be aligned and engaged after rotating a certain angle. After the driving member 271 and the fastener 24 are engaged, the handle 261 is continuously rotated to drive the driving member 271 to drive the fastener 24 to rotate such that the fastener 24 and the locking member 22 are locked through screw threads.

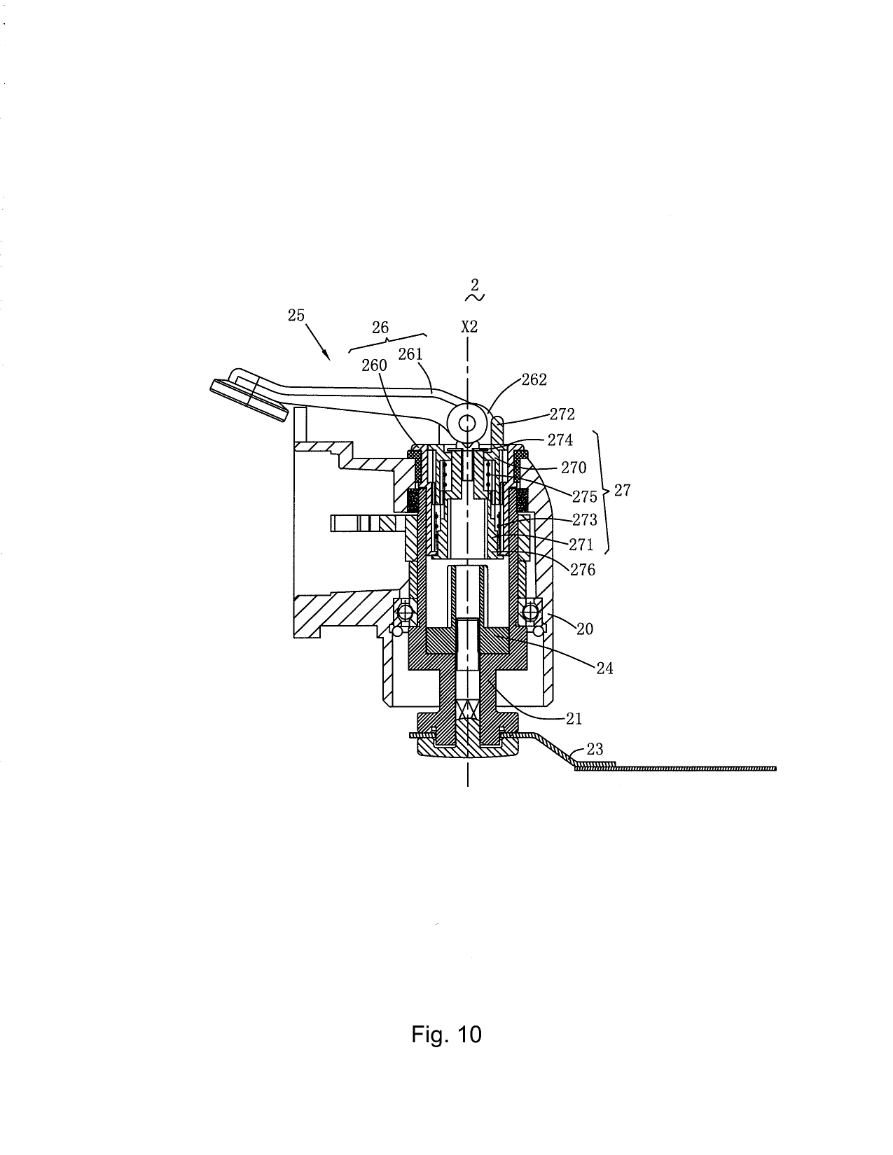

As shown in FIG. 10, when the fastener 24 and the locking member 22 are completely locked, the handle 261 will be shifted to the initial position and release the supporting member 270. By the action of the first spring 273, the supporting member 270 axially moves upward and drives the driving member 271 together to return to the initial position through the spacer 274, and then the driving member 271 is disengaged with the fastener 24.

### Embodiment 3

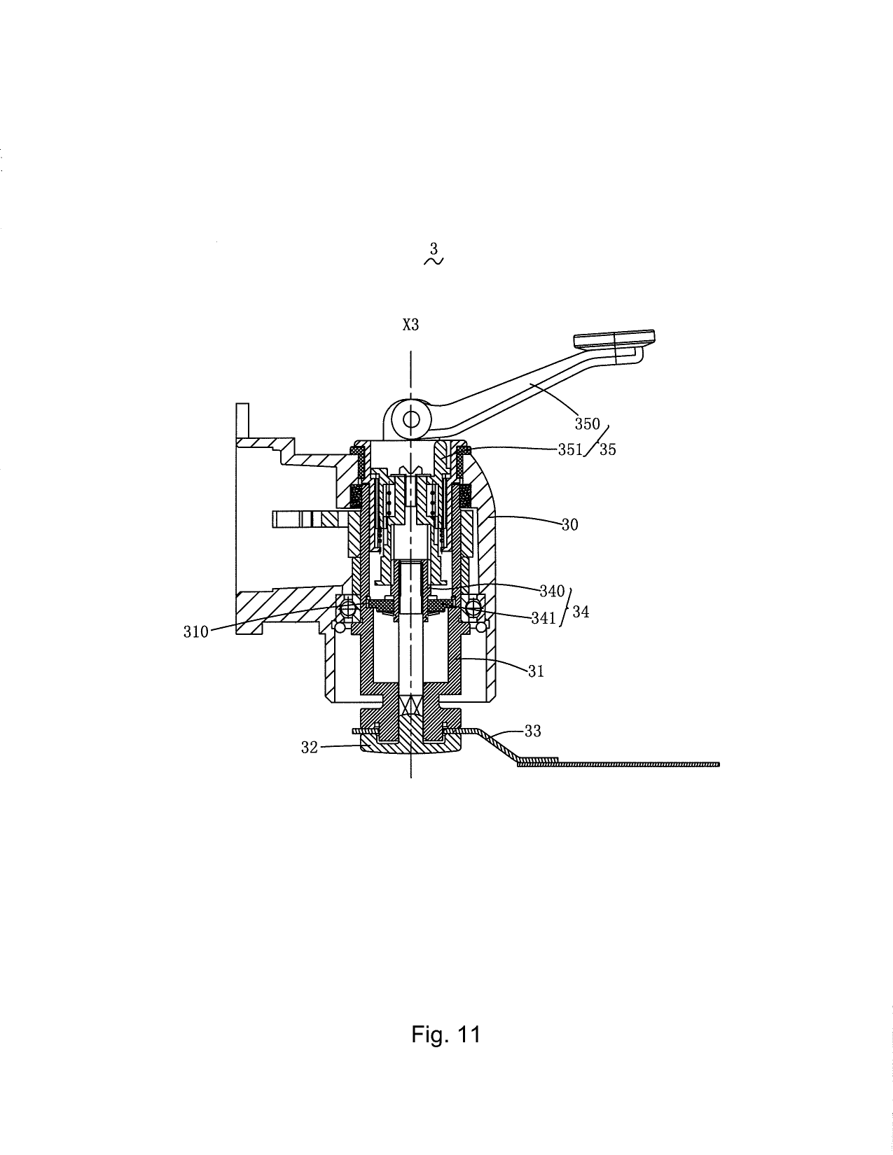

The following is a brief description of embodiment three of the present invention with reference to the FIG. 11. An oscillation tool 3 comprises a housing 30, an output shaft 31 installed in the housing 30, a locking member 32 inserted into the output shaft 31, a head 33 clamped between the locking member 32 and the output shaft 31, a fastener 34 received in the output shaft 31 and used for locking the locking member 32, and a driving mechanism 35 for driving the fastener 34 to rotate around the axis X3 of the output shaft 31. The driving mechanism 35 comprises an operating assembly 350 and a driving assembly 351. The operating assembly 350 is operable to drive the driving assembly 351 to rotate. The oscillation tool 3 in the second embodiment is different from the oscillation tool 2 in the second embodiment only in the fastener 34.

The fastener 34 is installed in the output shaft 31 in an axially immobilized way to avoid axial movement in the output shaft 31. The fastener 34 specifically comprises a fastening portion 340 with internal screw threads and an annular base 341 sleeved on the fastening portion 340. The fastening portion 340 cannot rotate with respect to the base 341. The external edge of the base 341 is received in the corresponding receiving groove 310 of the output shaft 31 and can rotate in the receiving groove 310.

During using, the driving mechanism 35 and the fastener are engaged, and then the operating assembly 350 is operable to rotate around the axis X3 to drive the driving assembly 351 to rotate and further drive the fastener 34 to rotate. After the fastener 34 and the locking member 32 are engaged through screw threads, the axial force generated by relative rotation drives the locking member 32 to axially move upward and finally stably clamp the head 33 between the output shaft 31 and the locking member 32.

### Embodiment 4

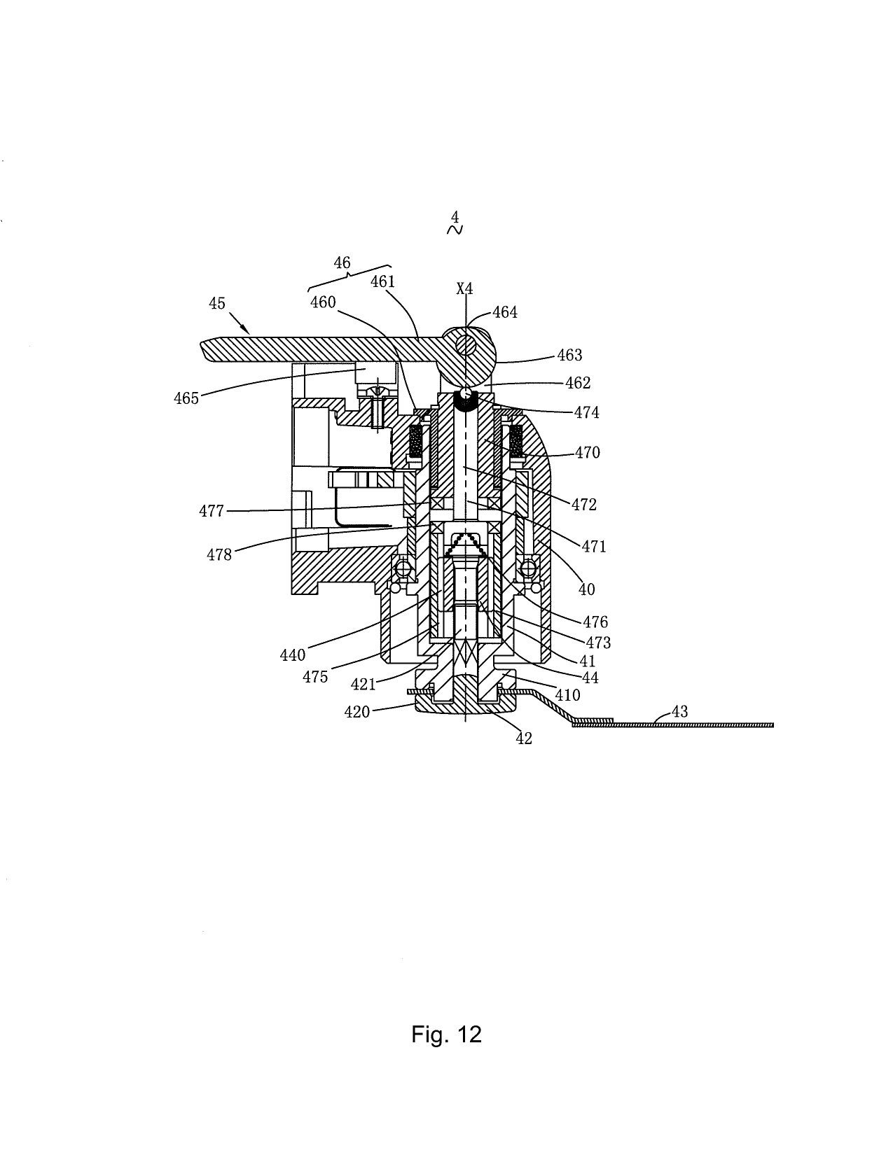

As shown in FIGS. 12-14, the fourth embodiment of the present invention also discloses an oscillating type power tool, namely an oscillation tool 4. The oscillation tool 4 comprises a housing 40, an output shaft 41 installed in the housing 40, a locking member 42 inserted into the output shaft 41, a head 43 clamped between the locking member 42 and the output shaft 41, a fastener 44 received in the output shaft 41 and used for locking the locking member 42, and a driving mechanism 45 for driving the fastener 44 to rotate around the axis X4 of the output shaft 41.

As shown in FIG. 12, in comparison with the first and second embodiment, the driving mechanism 45 has a different structure. The driving mechanism 45 specially comprises an operating assembly 46 and a driving assembly 47. The operating assembly 46 is operable to drive the driving assembly 47 to rotate. The operating assembly 46 comprises a cylindrical sleeve 460 installed on the top of the housing 40 and a handle 461. The sleeve 460 is axially arranged and can rotate with respect to the housing 40, the two opposite sides thereof axially extend upward to form two ear portions 462, while the bottom extends into the output shaft 41. The distal end of the handle 461 is pivoted between the two ear portions 462 by a shaft 466, and can pivot with respect to the sleeve 460 in a scope of 180 degrees. The distal end of the handle 461 is ball-shaped and has a first cam face 463 and a second cam face 464. When the handle 461 is located at the initial position, the first cam face 463 contacts with the driving assembly 47; and when the handle 461 is pivoted to the 180-degree open position, the second cam face 464 contacts with the driving assembly 47.

The driving assembly 47 is used for selectively driving the fastener 44, wherein the fastener 44 is hollow and cylindrical and has internal screw threads, and the periphery thereof is provided with a vertical first gear portion 440; moreover, the fastener 44 can move axially. The driving assembly 47 specifically comprises a first driving member 470 and a second driving member 471 passing through the driving member 470 to contact with the handle 461; and the first driving member 470 can rotate around the axis X4 with respect to the second driving member 471. The upper part of the second driving member 471 is provided with a pressure lever portion 472, while the lower part is provided with a driving portion 473 with an increasing diameter. The pressure lever portion 472 is cylindrical, and the top thereof is installed with a ball 474 contacting with the handle 461. The driving portion 473 is shaped as a barrel with bottom open; the inner wall is installed with a second gear portion 475 which is engaged with the first gear portion 440 and can axially slide; and a spring 476 is arranged between the top wall and the top of the fastener 44. In this embodiment, the spring 476 is a pressure spring.

The first driving member 470 is hollow and cylindrical, sleeved on the pressure lever portion 472 of the second driving member 471, and the top end is axially supported on the sleeve 460 and therefore cannot move axially. The bottom of the first driving member 470 is also provided with a first end tooth 477; correspondingly, the shoulder of the second driving member 471 is provided with a second end tooth 478 capable of being engaged with the first end tooth 477.

The specific operation process of the oscillation tool 4 is further described with reference to the FIGS. 12-14. In FIG. 12, the locking member 42 is inserted into the output shaft 41 from the lower side and clamps the head 43 between the flange plate 410 of the output shaft 41 and the flange portion 420 of the locking member 42. Meanwhile, the fastener 44 is pushed by the pole portion 421 of the locking member 452 to axially move upward at a distance, and the second driving member 471 cannot move because its top is pressed against the first cam face 463 of the handle 461 via the ball 474, so the spring 476 cannot be correspondingly compressed. The first end tooth 477 of the first driving member 470 and the second end tooth 478 of the second driving member 471 are kept at a certain distance; when the operating assembly 45 rotates, it can only drive the first driving member 470 to rotate and cannot drive the second driving member 471 to rotate.

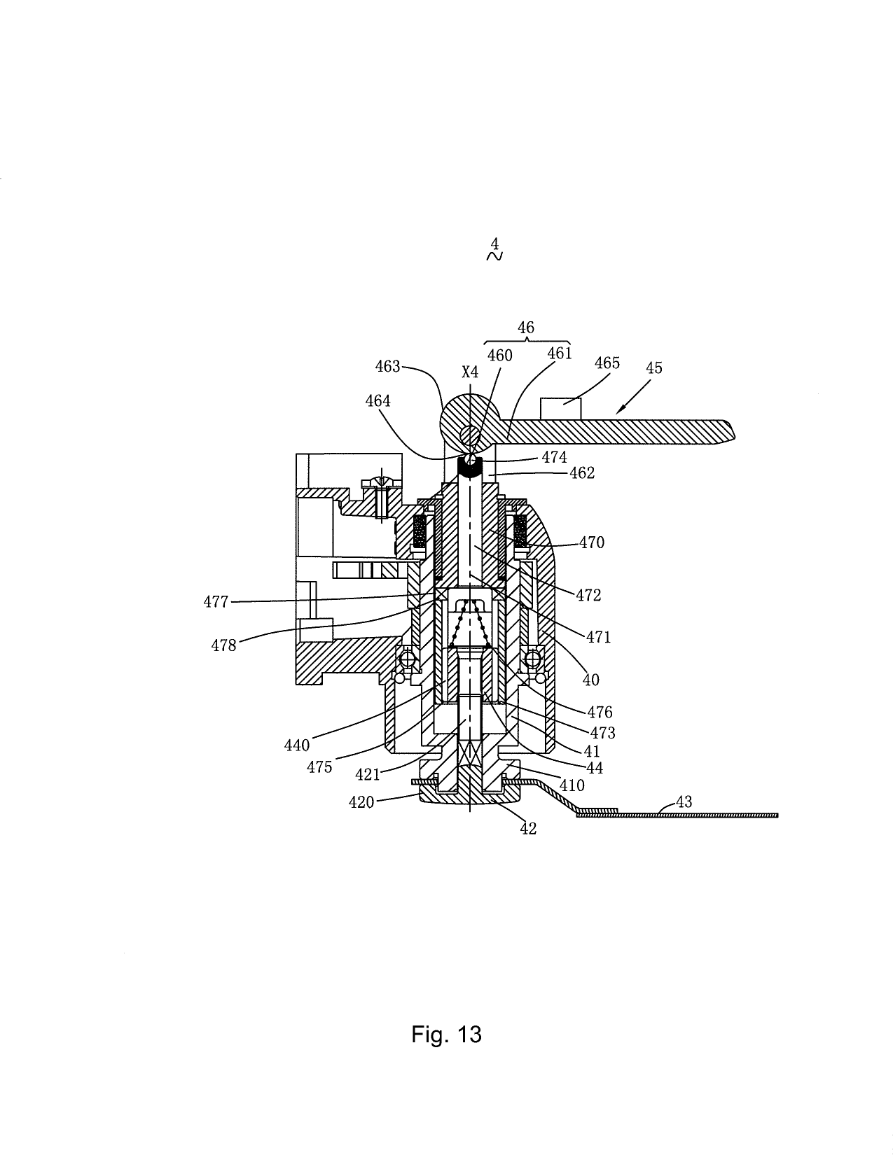

As shown in FIG. 13, the handle 461 is operable to pivot 180 degrees from the initial position to the open position; at this time, the first cam face 463 of the handle 461 is disengaged with the ball 474 of the second driving member 471, and instead, the second cam face 464 is engaged with the steel ball 474. The distance from the first cam face 463 to the pivot center of the handle 461 is far than that from the second cam face 464 to the pivot center of the handle 461, so by the elastic force of the spring 476, the second driving member 471 axially moves upward at a certain distance and finally enables the second end tooth 478 thereof to be engaged with the first end tooth 477 of the first driving member 470 in a way of failing to engage relatively. At this moment, the sleeve 460 can be driven by the handle 461 to rotate and drives the first driving member 470 to rotate; by engagement between the first end tooth 477 and the second end tooth 478, the second driving piece 478 is driven to rotate; by engagement between the second gear portion 475 and the first gear portion 440, the second driving member 471 drives the fastener 44 to start to rotate with respect to the locking member 42 and fastened through screw threads.

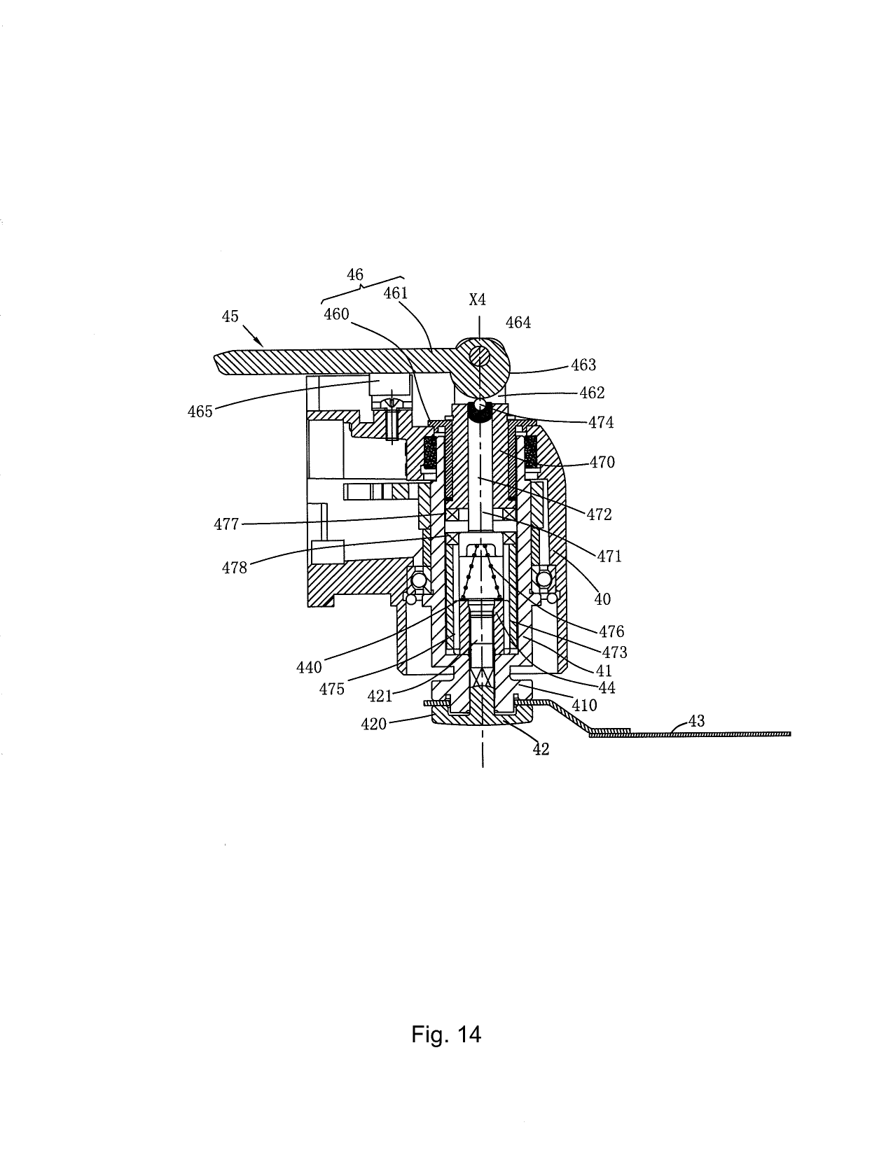

As shown in FIG. 14, the driving mechanism 45 has driven the fastener 44 and the locking member 42 to be completely locked and finally stably clamp the head 43 between the flange plate 410 of the output shaft 41 and the flange portion 420 of the locking member 42. After the head 43 is axially locked, the handle 461 shall be shifted to the initial position, and the blocking member 465 on the handle 461 is buckled on the housing 40 so as to fix the handle 461. The first cam face 463 is matched with the ball 474 to press the second driving member 471 downward and move at a certain distance such that finally the second end tooth 478 of the second driving member 471 is axially separated from the first end tooth 477 of the first driving member 470. Therefore, when the oscillation tool 4 is working and when the output shaft 41 drives the head 43 to oscillate in a reciprocating way, only the ball 474 of the second driving member 471 is driven to oscillate with the first cam face 463 with respect to the handle 461, while the first driving member 470 and the sleeve 460 are not driven to oscillate to influence the operation feel.

We claim:

1. A power tool, comprising:
a housing,
an output shaft for installing and driving a head to work,
a locking member for fixing said head on said receiving portion of said output shaft,
a fastener supported on said output shaft for locking said locking member,
a driving mechanism, rotationally installed on said housing, and
wherein said driving mechanism is operable to rotate along a first direction to drive said fastener and said locking member to be screwed, and is able to rotate along a direction opposite to said first direction to drive said fastener and said locking member to be loosened.

2. The power tool according to claim 1, wherein said driving mechanism comprises an operating assembly and a driving assembly connected with said operating assembly, said operating assembly being operable to move said driving assembly to be engaged or disengaged with said fastener.

3. The power tool according to claim 2, wherein a spring is axially arranged between said driving assembly and said housing, and provides a spring force such that said driving assembly can axially move in a reciprocating way.

4. The power tool according to claim 3, wherein said operating assembly is a handle pivoted on said driving assembly, said handle being provided with a cam portion, said cam portion being matched with said housing to axially move said driving assembly.

5. The power tool according to claim 2, wherein said operating assembly comprises a sleeve installed on said housing and the handle pivoted on said sleeve, and a first spring is arranged between said driving assembly and said sleeve.

6. The power tool according to claim 5, wherein said driving assembly comprises a supporting member axially supported on said sleeve and a driving member axially supported on said supporting member, and a second spring is axially arranged between said supporting member and said driving member.

7. The power tool according to claim 2, wherein said driving member comprises a first driving member and a second driving member, said second driving member being always engaged with said fastener and can move axially relatively, said operating member driving said second spring to be engaged with the first driving member so as to drive said fastener to rotate.

8. The power tool according to claim 1, wherein said locking member comprises a pole portion capable of being inserted into said output shaft, the free end of said pole portion being provided with external screw threads, said fastener being provided with a threaded bore, said threaded bore being provided with internal screw threads capable of being engaged with said external screw threads of said pole portion.

9. The power tool according to claim 1, wherein said fastener is capable of moving axially.

10. The power tool according to claim 1, wherein said driving mechanism is located at an end away from said receiving portion of said output shaft.

11. The power tool according to claim 1, wherein the rotation angle of said driving mechanism is greater than 90 degrees.

12. The power tool according to claim 11, wherein the rotation angle of said driving mechanism is greater than 360 degrees and less than 1,080 degrees.

13. An operation method for installing a head into a power tool, said power tool comprising a housing, an output shaft configured to install and drive the head to work and provided with a receiving portion that extends out of said housing, a locking member for fixing said head on said receiving portion of said output shaft, a fastener supported on said output shaft for locking said locking member, and a driving mechanism rotationally installed on said housing, the operation method comprising:
installing said head between said receiving portion of said output shaft and said locking member; and
rotating said driving mechanism around the axis of said output shaft along one direction to drive said fastener and said locking member to be locked by screw threads.

14. The operation method according to claim 13, wherein said driving mechanism comprises an operating assembly and a driving assembly connected with the said operating assembly and the operation method further comprises: said operating assembly axially drives said driving assembly to be engaged or disengaged with said fastener before the driving mechanism is rotated.

15. The operation method according to claim 14, wherein the rotation angle of said driving mechanism is greater than 90 degrees.
